(19) United States
(12) Patent Application Publication
(10) Pub. No.: US 2026/0275946 A1
(43) Pub. Date: Sep. 17, 2026

(54) DUAL-FUEL INJECTOR

(71) Applicant: PHINIA DELPHI LUXEMBOURG SARL, Belvaux (LU)

(72) Inventors: Mark Stephen HARPER, Gloucestershire (GB); Stephen CROSSLEY, Bristol (GB)

(21) Appl. No.: 19/166,778

(22) PCT Filed: Mar. 21, 2024
(86) PCT No.: PCT/EP2024/057688

§ 371 Date: Sep. 18, 2025

(30) Foreign Application Priority Data
Mar. 21, 2023 (GB) 2304124.7
Mar. 21, 2023 (GB) 2304126.2
Mar. 21, 2023 (GB) 2304127.0

(51) Int. Cl. F02M 43/04; F02D 19/06; F02M 45/02; F02M 47/02; F02M 61/10

(52) U.S. Cl. CPC F02M 43/04; F02D 19/0689; F02M 45/02; F02M 47/02; F02M 61/10

(57) ABSTRACT

A dual-fuel injector for injecting two separate fuels into a combustion chamber of an internal combustion engine includes a nozzle body housing a first fuel needle valve and a second fuel needle valve. The dual-fuel injector further includes a first fuel control chamber defined at least in part by an upper end of the first fuel needle valve such that varying a first pressure in the first fuel control chamber varies the force on the upper end of the first fuel needle valve. Further, the dual-fuel injector includes a second fuel control chamber defined at least in part by an upper end of the second fuel needle valve such that varying a second pressure in the second fuel control chamber varies the force on the upper end of the second fuel needle valve. The dual-fuel injector includes a first fuel control valve defining a first switching volume fluidly coupled to the first fuel control chamber for actuating the first fuel needle valve, and a second fuel control valve defining a second switching volume fluidly coupled to the second fuel control chamber for actuating the second fuel needle valve. The dual-fuel injector further includes an annular hydraulic sealing gallery extending around an outer surface of the first fuel needle valve. The annular hydraulic sealing gallery is fluidly coupled to a source of high-pressure fluid. Additionally, the annular hydraulic sealing gallery is fluidly coupled to at least one of the first switching volume and/or the second switching volume such that the respective switching volume is fluidly coupled to the source of high-pressure fluid via the sealing gallery.

### TECHNICAL FIELD

The present invention relates generally to fuel injectors and more specifically to a dual-fuel injector for an internal combustion engine.

### BACKGROUND

Internal combustion (IC) engines are typically powered by combusting a fuel, such as petrol (gasoline) or diesel, in a combustion chamber. New technologies have been developed to increase fuel efficiency and reduce emissions of IC engines. One such development involves the combustion of two separate fuels within the combustion chamber of a dual-fuel engine. For example, a first fuel, such as methane or hydrogen gas, may be supplied to the combustion chamber due to its advantageous combustion or emissions characteristics. A second fuel, such as petrol or diesel, may be supplied to the combustion chamber to improve the reliability and timing of the combustion of the first fuel.

In a dual-fuel engine, the first and second fuels may be supplied to the combustion chamber in a number of different ways. Some examples include: mixing the two fuels together with air in an inlet manifold before supplying the fuel/air mixture to the combustion chamber through an inlet valve; supplying air and the first fuel through the inlet valve and subsequently injecting the second fuel to the combustion chamber; or injecting each fuel to the combustion chamber using separate fuel injectors. However, each of these methods has drawbacks in terms of efficiency and/or packaging of the engine components.

Dual-fuel injectors, i.e. singular injectors that inject both the first and second fuels to the combustion chamber, have been developed in an attempt to overcome these drawbacks. However, significant challenges remain. For example, dual-fuel injectors may require more ancillary components packaged into a similar sized packing envelope as a comparable single-fuel injector. Additionally, dual-fuel injectors may require longer and more complex hydraulic systems to control valves for regulating delivery of each fuel. Packaging such hydraulic systems can be challenging and in some examples unavoidable packaging constraints may have an adverse effect on valve timings and combustion performance.

It is against this background that the present invention has been devised.

### SUMMARY

According to the present invention there is provided a dual-fuel injector for injecting two separate fuels into a combustion chamber of an internal combustion engine. The dual-fuel injector comprises a nozzle body housing a first fuel needle valve and a second fuel needle valve. The dual-fuel injector further comprises a first fuel control chamber defined at least in part by an upper end of the first fuel needle valve such that varying a first pressure in the first fuel control chamber varies the force on the upper end of the first fuel needle valve. Further, the dual-fuel injector comprises a second fuel control chamber defined at least in part by an upper end of the second fuel needle valve such that varying a second pressure in the second fuel control chamber varies the force on the upper end of the second fuel needle valve. The dual-fuel injector comprises a first fuel control valve defining a first switching volume fluidly coupled to the first fuel control chamber for actuating the first fuel needle valve, and a second fuel control valve defining a second switching volume fluidly coupled to the second fuel control chamber for actuating the second fuel needle valve. The dual-fuel injector further includes an annular hydraulic sealing gallery extending around an outer surface of the first fuel needle valve. The annular hydraulic sealing gallery is fluidly coupled to a source of high-pressure fluid. Additionally, the annular hydraulic sealing gallery is fluidly coupled to at least one of the first switching volume and/or the second switching volume such that the respective switching volume is fluidly coupled to the source of high-pressure fluid via the sealing gallery.

In some preferred examples, the annular hydraulic sealing gallery may be fluidly coupled to the source of high-pressure fluid and to both the first switching volume and the second switching volume. Accordingly, both the first and second switching volumes may be fluidly coupled to the source of high-pressure fluid via the sealing gallery. It follows that both the first and second fuel control chambers may therefore be selectively fluidly coupled to the source of high-pressure fluid via the sealing gallery and the respective switching volume of the respective control valve.

The annular hydraulic sealing gallery advantageously performs a plurality of functions, thereby reducing the complexity of hydraulic routing in the dual-fuel injector and saving space such that the overall size of the injector can be reduced. For example, by fluidly coupling the sealing gallery to at least one of the switching volumes, the respective switching volume and associated control chamber can be fed, i.e. refilled, from the source of high-pressure fluid via the sealing gallery. Accordingly, the dual-fuel injector does not require additional hydraulic connections, conduits and seals for feeding at least one of the switching volumes, as this is instead fed via the sealing gallery, making use of the hydraulic services already included in the injector for the sealing gallery.

In some examples, the first fuel control valve may be a three-way valve. The first fuel switching volume may have a diameter of less than 5 mm, preferably less than 3 mm, most preferably less than 1.5 mm. The first fuel switching volume may provide a fluid flow path between the first fuel control chamber and the source of high-pressure fluid and another fluid flow path between the first fuel control chamber and a low-pressure fluid drain. The first fuel switching volume may be in fluid communication with the first fuel control chamber via a first fuel control conduit. The first fuel control chamber and first fuel control conduit collectively define a first fuel control volume.

In some examples, the first fuel control valve may comprise a first plunger configured to move along a first control valve axis to selectively fluidly couple the first fuel control chamber to a low-pressure fluid drain or to the source of high-pressure fluid via the annular hydraulic sealing gallery. That is to say, the first plunger may be configured to selectively block one fluid flow path, i.e. between the first fuel control chamber and the source of high-pressure fluid, whilst facilitating fluid communication through the other fluid flow path, i.e. between the first fuel control chamber and a low-pressure fluid drain, or vice versa. Accordingly, the first plunger may be arranged in the first switching volume, in some preferred examples. The first fuel control valve is therefore preferably configured such that the first plunger is selectively moveable along the first control valve axis between a first position and a second position. The first fuel control valve is preferably configured such that, in the first position, the first plunger is configured to facilitate one of either a) fluidly couple the first fuel control chamber to the source of high-pressure fluid and fluidly decouple (i.e. block fluid communication between) the first fuel control chamber and the low-pressure fluid drain, or b) fluidly couple the first fuel control chamber to the low-pressure fluid drain and fluidly decouple the first fuel control chamber and the source of high-pressure fluid. The first fuel control valve is preferably configured such that in the second position, the first plunger is configured to facilitate the other of either a) fluidly couple the first fuel control chamber to the source of high-pressure fluid and fluidly decouple the first fuel control chamber and the low-pressure fluid drain, or b) fluidly couple the first fuel control chamber to the low-pressure fluid drain and fluidly decouple the first fuel control chamber and the source of high-pressure fluid,

In some examples, the second fuel control valve may be a three-way valve. The second fuel switching volume may have a diameter of less than 5 mm, preferably less than 3 mm, and most preferably less than 1.5 mm. The second fuel switching volume may provide a fluid flow path between the second fuel control chamber and the source of high-pressure fluid and another fluid flow path between the second fuel control chamber and a low-pressure fluid drain. The second fuel switching volume may be in fluid communication with the second fuel control chamber via a second fuel control conduit. The second fuel control chamber and second fuel control conduit collectively define a second fuel control volume.

The second fuel control valve may comprise a second plunger configured to move along a second control valve axis to selectively fluidly couple the second fuel control chamber to a low-pressure fluid drain or to the source of high-pressure fluid via the annular hydraulic sealing gallery. For example, the second plunger may be configured to selectively block one fluid flow path, i.e. between the second fuel control chamber and the source of high-pressure fluid, whilst facilitating fluid communication through the other fluid flow path, i.e. between the second fuel control chamber and a low-pressure fluid drain, or vice versa. Accordingly, the second plunger may be arranged in the second switching volume, in some preferred examples. The second fuel control valve is therefore preferably configured such that the second plunger is selectively moveable along the second control valve axis between a first position and a second position. The second fuel control valve is preferably configured such that, in the first position, the second plunger is configured to facilitate one of either a) fluidly couple the second fuel control chamber to the source of high-pressure fluid and fluidly decouple (i.e. block fluid communication between) the second fuel control chamber and the low-pressure fluid drain, or b) fluidly couple the second fuel control chamber to the low-pressure fluid drain and fluidly decouple the second fuel control chamber and the source of high-pressure fluid. The second fuel control valve is preferably configured such that in the second position, the second plunger is configured to facilitate the other one of either a) fluidly couple the second fuel control chamber to the source of high-pressure fluid and fluidly decouple the second fuel control chamber and the low-pressure fluid drain, or b) fluidly couple the second fuel control chamber to the low-pressure fluid drain and fluidly decouple the second fuel control chamber and the source of high-pressure fluid,

In some examples, the first fuel needle valve and second fuel needle valve may be comprised in a dual needle valve arrangement. For example, the first fuel needle valve may define an internal bore, and the second fuel needle valve may be slidably received within the internal bore. The second fuel needle valve is preferably slidably received within the first fuel needle valve bore with a matched clearance fit. For example, the first fuel needle valve bore and second fuel needle valve may have a diametral clearance of 2 μm to 4 μm, at the matched clearance, in some preferred examples.

The first fuel needle valve defines a first needle valve axis, i.e. a longitudinal axis, along which the first fuel needle valve moves, and the second fuel needle valve defines a second needle valve axis, i.e. a longitudinal axis, along which the second fuel needle valve moves. In some preferred examples, the second fuel needle valve may be co-axial with the first fuel needle valve.

In some examples the dual-fuel injector may further comprise one or more connection ducts extending radially outward from the annular hydraulic sealing gallery. In such an example, the or each switching volume may be fluidly coupled to the annular hydraulic sealing gallery via a respective feed drilling connecting the switching volume and the connection duct. In some preferred examples, the or each feed drilling may be substantially straight. It will be appreciated that each connection duct provides a conduit extending the radius (i.e. width) of the annular sealing gallery in discrete locations for connecting the respective feed drilling to the sealing gallery. This facilitates the use of substantially straight feed drillings for connecting the respective switching volume to the sealing gallery (via a connection duct). Accordingly, the or each connection duct facilitates simpler manufacture of the dual-fuel injector.

In some preferred examples, the nozzle body may comprise distinct portions configured to serve separate functions. For example, the nozzle body may comprise a lower portion configured to extend into the combustion chamber. As such, the lower portion of the nozzle body may be formed of a material capable of withstanding the high temperatures and pressures in the combustion chamber. The nozzle body may comprise an upper portion that comprises hydraulic conduits for routing the fuels and hydraulic control fluids around the injector. In some examples the upper portion of the nozzle body may also provide attachment locations for attaching ancillary components, such as control valves, to the injector.

In some examples, the nozzle body may define a needle guide portion. The needle guide portion may be defined by the upper portion of the nozzle body. The upper end of the first fuel needle valve may be slidably received in the needle guide portion. In some preferred examples, the upper end of the first fuel needle valve may be received in the needle guide portion with a matched clearance fit. The matched clearance fit, i.e. matched diameter, is preferably defined between an external diameter of the upper end of the first fuel needle valve and an internal diameter of the needle guide portion. For example, the needle guide portion and upper end of the first fuel needle valve may have a diametral clearance of 2 μm to 3.5 μm, at the matched clearance, in some preferred examples.

In some examples, the nozzle body may define at least part of a first fuel accumulator volume and one or more first fuel injection outlets in fluid communication with the first fuel accumulator volume for injecting the first fuel from the first fuel accumulator volume into the combustion chamber. For example, the first fuel accumulator volume may be defined, at least in part, between the first fuel needle valve and an interior surface of the nozzle body. The first fuel accumulator volume may be defined, at least in part, by a middle portion of the nozzle body, and the or each first fuel injection outlet may be defined by the lower portion of the nozzle body. The first fuel needle valve is preferably configured to control the injection of the first fuel from the first fuel accumulator volume to the combustion chamber via the or each first fuel injection outlet.

In some examples, the nozzle body may define a first fuel valve seat portion. The first fuel valve seat portion may define the or each first fuel injection outlet. The dual-fuel injector may further comprise a first biasing means configured to bias the first fuel needle valve into engagement with the first fuel valve seat portion. Accordingly, the first biasing means may bias the first fuel needle valve into closing, i.e. blocking, the or each first fuel injection outlet. Similarly, increasing the pressure in the first fuel control chamber, for example by selectively fluidly coupling the first fuel control chamber to the source of high-pressure fluid, may push the first fuel needle valve into engaging the first fuel valve seat portion, thereby closing the or each first fuel injection outlet. The first biasing means may advantageously accelerate closing of the first fuel needle valve at the end of the first fuel injection. This may be beneficial for combustion and fuel efficiency.

In some preferred examples, the first biasing means may be disposed around the first fuel needle valve. In some preferred examples, the first biasing means may comprise a coil spring extending around an outer surface of the first fuel needle valve. In some examples, the first biasing means may be situated within the first fuel accumulator volume. For example, the first biasing means may be located between the first fuel needle valve and an internal bore of the nozzle body. Accordingly, the first biasing means may be situated in an entirely separate portion of the injector compared to the first fuel control chamber. This means that there is no requirement to dimension the first fuel control chamber to accommodate the first biasing means, meaning that the first fuel control chamber, and by extension the first fuel control volume, can be minimised, thereby improving fuel delivery and combustion performance as previously described.

In some examples, the first fuel needle valve may comprise a shoulder portion and the first biasing means may abut or engage the shoulder portion of the first fuel needle valve. Advantageously, the first biasing means may be configured to bias the first fuel needle valve along the first needle valve axis without necessarily bearing against the upper end of the first fuel needle valve. As such, the volume of the first fuel control chamber can be minimised, which is advantageous for the reasons described previously.

Further, in some examples, the dual-fuel injector may additionally comprise a collar coupled to the first fuel needle valve. For example, the collar may define the shoulder portion. In such an example, the first biasing means may engage the collar and a portion of the nozzle body to bias the first fuel needle valve into engagement with the first fuel valve seat portion. example, the nozzle body may comprise a seat configured for engaging the first biasing means. The first biasing means is preferably held in compression between the collar and the nozzle body seat to bias the first fuel needle valve. In some examples, the collar may be press-fitted to the first fuel needle valve, i.e. to the outer surface of the first fuel needle valve. Coupling a collar to the first fuel needle valve for engaging the first biasing means may simplify manufacture and assembly of the dual-fuel injector.

In some examples, the nozzle body may comprise an assembly of a plurality of nozzle body sections. For example, the nozzle body may comprise separate nozzle body sections at least partially defining the previously-described portions of the nozzle body. For example, the nozzle body may comprise a tip section that defines at least part of the lower portion of the nozzle body and therefore extends into the combustion chamber. The tip section of the nozzle body may comprise a different material to the or each other nozzle body section to withstand the high temperatures and pressures in the combustion chamber. For example the tip section of the nozzle body may define the first fuel valve seat, and accordingly, the tip section may also define the or each first fuel injection outlet. Additionally or alternatively, in some examples the tip section of the nozzle body may define at least part of the first fuel accumulator volume.

In some examples, the first fuel accumulator volume and the annular hydraulic sealing gallery may be separated by a first portion of matched clearance fit between the first fuel needle valve and the needle guide portion. The first portion of matched clearance fit may be referred to as a first matched clearance interface. As previously described, in some preferred examples the matched clearance fit, i.e. matched diameter, between the upper end of the first fuel needle valve and the needle guide portion may be achieved by a diametral clearance of 2 μm to 3.5 μm between an external diameter of the upper end of the first fuel needle valve and an internal diameter of the needle guide portion, at the first portion of matched clearance fit. The first portion of matched clearance fit helps to prevent fuel from the first fuel accumulator volume from entering the sealing gallery and/or mixing with the fluid in the sealing gallery.

In some preferred examples, the annular hydraulic sealing gallery may comprise a fluid maintained at a higher pressure than the first fuel in the first fuel accumulator volume. Accordingly there may be a pressure differential that inhibits any movement of the first fuel from the first fuel accumulator volume towards the sealing gallery and/or the first fuel control chamber and/or the second fuel control chamber. Accordingly, maintaining fluid in the annular sealing gallery at a higher pressure may improve the performance of the seal, i.e. may increase the seals ability to block ingress of the first fuel to the first fuel control chamber in use. The sealing gallery may therefore help to prevent mixing of the first fuel with the high-pressure fluid in the sealing gallery and or first fuel control chamber, thereby avoiding contamination of the source of high-pressure fluid.

In some examples, the first fuel control chamber may be defined at least in part by a ceiling surface of the needle guide portion. For example, a ceiling of the first fuel control chamber may be defined by the ceiling surface of the needle guide portion. Accordingly, the first fuel control chamber may be defined between the upper end of the first fuel needle valve and the ceiling surface of the needle guide portion.

In some examples, the first fuel control chamber and the annular hydraulic sealing gallery may be separated by a second portion of matched clearance fit between the first fuel needle valve and the needle guide portion. The second portion of matched clearance fit may be referred to as a second matched clearance interface. As described previously, the matched clearance between the first fuel needle valve and the needle guide portion is preferably in the form of a diametral clearance of 2 μm to 3.5 μm between the external diameter of the upper end of the first fuel needle valve and the internal diameter of the needle guide portion, in some preferred examples.

In some particularly advantageous examples, the fluid in the first fuel control chamber and the fluid in the annular hydraulic sealing gallery may be the same fluid. Further, the maximum pressure of the fluid in the first fuel control chamber may be substantially the same as the pressure of the fluid in the annular sealing gallery, for example if both the annular hydraulic sealing gallery and the first fuel control chamber are fluidly coupled to the same source of high-pressure fluid. Accordingly, there may be very little or no pressure differential to motivate fluid between the control chamber and the sealing gallery. Further, any transfer of fluid between the first fuel control chamber and the sealing gallery is not particularly detrimental if the same fluid is in each of the sealing gallery and first fuel control chamber.

In some preferred examples, the fluid in the sealing gallery may be the second fuel. In some examples the fluid fed to the first fuel control chamber and/or to the second fuel control chamber may be the second fuel. Accordingly, the source of high-pressure fluid may comprise the second fuel. In some examples, the source of high-pressure fluid may be a common rail fuel system.

As noted above, in some examples, the first fuel control chamber may be defined at least in part by a ceiling surface of the needle guide portion. In such an example, the nozzle body may comprise a bore extending from an aperture defined in the ceiling surface of the needle guide portion. Further, the upper end of the second fuel needle valve may be received within the bore, i.e. within the bore extending from the aperture in the ceiling surface of the needle guide portion, and the second fuel control chamber may therefore be defined, at least in part, by that bore.

In some examples, the upper end of the first fuel needle valve may define an upper surface comprising an aperture. For reference, the first fuel control chamber may be defined at least in part by the upper surface of the first fuel needle valve. Further, the first fuel needle valve may comprise a bore extending from the aperture through the upper end of the first fuel needle valve. The second fuel needle valve may be slidably received within the first fuel needle valve bore in some examples. Accordingly, the second fuel needle valve may protrude from the aperture such that the upper end of the second fuel needle valve extends above the upper end of the first fuel needle valve. Accordingly, the second fuel needle valve may operate substantially independent of the first fuel needle valve, in use.

In some examples, the second fuel needle valve may extend through the first fuel control chamber. Accordingly, in some preferred examples, the first fuel control chamber may be defined at least in part by an outer surface of the second fuel needle valve. As such, the fluid in the first fuel control chamber may contact an outer surface of the second fuel needle valve, in use. Accordingly, the first fuel control chamber may be manufactured as a hollow, open space, and the second fuel needle valve may extend through the open space. Advantageously such a configuration may facilitate relatively simple manufacture of the first fuel control chamber.

In some examples, the first fuel control chamber may comprise a first central axis that is co-axial with the first needle valve axis. Locating the first fuel control chamber co-axially with the first needle valve may advantageously minimise the distance between the first fuel control valve and the first fuel control chamber. Accordingly, the first control volume may be minimised. This reduces the risk of wave activity in the first control volume and reduces delays in the hydraulic control of the first fuel needle valve, thereby accelerating valve response time as well as increasing the consistency and reliability of delivery of the first fuel to the combustion chamber.

In some preferred examples, the first fuel control chamber may define a substantially circular perimeter. For example, the first fuel control chamber may comprise a rotationally swept volume about the first central axis. As such, it will be appreciated that the first central axis defines the geometric centre of the first fuel control chamber, in some preferred examples. In some examples, the first fuel control chamber may form an annulus extending around a portion of the second fuel needle valve.

The first fuel needle valve may define a second fuel accumulator volume and one or more second fuel injection outlets in fluid communication with the second fuel accumulator volume for injecting the second fuel from the second fuel accumulator volume into the combustion chamber. For example, the second fuel accumulator volume may be defined, at least in part, between the second fuel needle valve and an interior surface of the first fuel needle valve. The second fuel needle valve is preferably configured to control the injection of the second fuel from the second fuel accumulator volume to the combustion chamber via the or each second fuel injection outlet.

In some examples, the first fuel needle valve may define a second fuel valve seat portion. The second fuel valve seat portion may define the or each second fuel injection outlet, in some examples. Further, the dual-fuel injector may additionally comprise a second biasing means configured to bias the second fuel needle valve into engagement with the second fuel valve seat portion. Accordingly, the second biasing means may bias the second fuel needle valve into closing, i.e. blocking, the or each second fuel injection outlet. Similarly, increasing the pressure in the second fuel control chamber, for example by selectively fluidly coupling the second fuel control chamber to the source of high-pressure fluid, may push the second fuel needle valve into engaging the second fuel valve seat portion, thereby closing the or each second fuel injection outlet. In some examples, the second biasing means may be disposed within the second fuel accumulator volume within the first fuel needle valve.

In some preferred examples, the second biasing means may comprise a coil spring extending around the outer surface of the second fuel needle valve. In some examples, the second fuel needle valve may comprise a shoulder configured for engaging the second biasing means. In some examples, the shoulder of the second fuel needle valve may be defined by a collar coupled to the outer surface of the second fuel needle valve. In preferred examples, the second biasing means may be held in compression between the shoulder of the second fuel needle valve and a ceiling of the second fuel accumulator volume.

Notably, in some preferred examples, the second biasing means may be disposed within the second fuel accumulator volume within the first fuel needle valve, whereas the second fuel control chamber may be defined at least in part by an upper surface of the upper end of the second fuel needle valve which extends above the upper end of the first fuel needle valve. Accordingly, in preferred examples, the second biasing means may be situated in an entirely separate location from the second fuel control chamber. The second fuel control chamber therefore does not need to be dimensioned to accommodate the second biasing means, and the volume of the second fuel control chamber may therefore be minimised.

In some examples, the first fuel needle valve may comprise one or more feed conduits facilitating fluid communication between the annular hydraulic sealing gallery and the second fuel accumulator volume. In some preferred examples, the first fuel needle valve may comprise a plurality of feed conduits extending between the sealing gallery and the second fuel accumulator volume. Further, where included, such feed conduits may be spaced at regular intervals around the circumference of the first fuel needle valve.

Apart from reducing the complexity of hydraulic routing through the injector as described previously, a multi-functional sealing gallery that supplies the second fuel to the second fuel accumulator volume via the feed conduits described above also improves the sealing performance of the first portion of matched clearance fit between the first fuel needle valve and the needle guide portion. For example, because the annular hydraulic sealing gallery facilitates the supply of the second fuel to the second fuel accumulator volume, the dual-fuel injector does not require an additional fuel supply gallery to facilitate the supply of fuel to the second fuel accumulator volume. As such, the first portion of matched clearance fit can be extended, i.e. can have an increased length, to provide a long uninterrupted portion of matched clearance between the first fuel needle valve and the needle guide portion. This advantageously improves the sealing performance to isolate the fluid in the annular hydraulic sealing gallery from the first fuel in the first fuel accumulator volume and vice versa. The multi-functional sealing gallery facilitates an extended first portion of matched clearance fit without necessitating an increase in the length and/or overall size of the dual-fuel injector.

In some preferred examples, each of the matched diameters referred to herein is preferably concentric to within to 0.5 μm of the first fuel needle valve axis.

In some examples, the first and second fuel control valves may be arranged side-by-side such that the first control valve axis extends parallel to the second control valve axis. In some preferred examples, both the first and second control valve axes may extend parallel to the first needle valve axis. Further, both the first and second control valve axes may be offset from the first needle valve axis such that neither control valve axis is co-axial with the first needle valve axis. In some examples, the first control valve axis and the second control valve axis may each be offset from the first needle valve axis by the same distance. Accordingly, in advantageous examples, neither control valve is prioritised over the other control valve, and instead both control conduits are optimised in terms of reducing the distance to the respective control chamber and thereby reducing the respective control volume.

The side-by-side arrangement of the first and second fuel control valves may facilitate a reduction in the overall size of the dual-fuel injector, as well as enabling improved valve movement control to improve combustion in the combustion chamber in use. For example, arranging the first and second fuel control valves side-by-side, with their respective valve axes parallel to, but not concentric with, the first needle valve axis means that the control valves can be provided close to the respective control chambers. Reducing the distance between the control valves, i.e. the switching volumes of the control valves, and the respective control chambers reduces the length of the control conduits and thereby also reduces each control volume. This in turn means that switching losses or control volume losses are minimised, needle valve responses (i.e. opening and closing rates) are accelerated, and hydraulic wave activity in each control volume is reduced, providing more accurate and consistent delivery of fuel into the combustion chamber.

In some examples, the dual-fuel injector may comprise a first control orifice via which the first fuel control chamber is in fluid communication with the first fuel control conduit. A flow area of the first control orifice, or a diameter of the first control orifice, may therefore influence the rate of flow into and out of the first fuel control chamber. Accordingly, the flow area or diameter of the first control orifice may influence the opening and closing rates of the first fuel needle valve. For example, the first control orifice may be configured to dampen i.e. slow, the opening rate of the first fuel needle valve when the first control valve is operated to fluidly connect the first fuel control chamber with the low-pressure fluid drain such that fluid in the first fuel control chamber is evacuated to the low-pressure fluid drain via the first control orifice. As such, the flow area of the first control orifice, or a diameter of the first control orifice, may be smaller than the flow area, or diameter, of the first control conduit.

In some examples, the dual-fuel injector may comprise a second control orifice via which the second fuel control chamber is in fluid communication with the second fuel control conduit. A flow area of the second control orifice, or a diameter of the second control orifice, may therefore influence the rate of flow into and out of the second fuel control chamber. Accordingly, the flow area or diameter of the second control orifice may influence the opening and closing rates of the second fuel needle valve. For example, the second control orifice may be configured to dampen i.e. slow, the opening rate of the second fuel needle valve when the second control valve is operated to fluidly connect the second fuel control chamber with the low-pressure fluid drain such that fluid in the second fuel control chamber is evacuated to the low-pressure fluid drain via the second control orifice. As such, the flow area of the second control orifice, or a diameter of the second control orifice, may be smaller than the flow area, or diameter, of the second control conduit.

The second fuel control chamber may comprise a second central axis that is co-axial with the first needle valve axis. Further, in some preferred examples, the second fuel control chamber may define a substantially circular perimeter. For example, the second fuel control chamber may comprise a rotationally swept volume about the second central axis. As such, it will be appreciated that the second central axis may define the geometric centre of the second fuel control chamber, in some preferred examples.

In some preferred examples, the first central axis and/or the second central axis may be co-axial with the second needle valve axis. It follows that in some preferred examples, the first and second needle valve axes, and the first and second central axes may all be co-axial with one another. Such an arrangement may be advantageous for manufacturing and assembly as well as loading and wear of the components in use. Additionally, such an arrangement may further facilitate a reduction in the respective control volumes by reducing the distance between the control valves and the control chambers.

To inject a dose of the first fuel into the combustion chamber, the dual-fuel injector may be operated to fluidly connect the first fuel control chamber to the low-pressure fluid drain, using the first fuel control valve, such that the first pressure in the first fuel control chamber decreases, thereby decreasing the force on the upper end of the first fuel needle valve. The pressure of the first fuel in the first fuel accumulator volume may therefore overcome the remaining closing force holding the first fuel needle valve against the first fuel valve seat such that the first fuel needle valve lifts and allows the first fuel to exit the first fuel accumulator volume into the combustion chamber.

In typical operating conditions, a dose of the second fuel may be injected into the combustion chamber during or after injection of the first fuel. Accordingly, the second pressure in the second fuel control chamber may be maintained, holding the second fuel needle valve in a closed position against the second fuel valve seat of the first fuel needle valve, during opening, i.e. lifting, of the first fuel needle valve. When held closed, the second fuel needle valve may therefore apply a force on the first fuel needle valve, because the second fuel needle valve can operate substantially independent of the first fuel needle valve. Accordingly, in some examples the second fuel needle valve may dampen, i.e. slow, the opening rate of the first fuel needle valve. Further, the additional force provided by the second fuel needle valve may accelerate the closing rate of the first fuel needle valve. Both of these effects are beneficial for combustion.

In some examples, the first fuel may be a gaseous fuel. For example, the first fuel may be a gas such as methane gas or hydrogen gas. Additionally or alternatively, the second fuel may be a liquid fuel. For example, the second fuel may be a liquid such as liquid diesel or liquid petrol (gasoline), in some examples. In some other examples, the first and second fuels may be the same type of fuel. For example, the first and second fuels may both be liquid fuels in some examples, or alternatively, the first and second fuels may both be gaseous fuels in other examples.

### BRIEF DESCRIPTION OF THE DRAWINGS

Examples of the present invention will now be described by way of non-limiting example only, with reference to the accompanying figures, in which:

FIG. 1 is a schematic cross-sectional view of a dual-fuel injector;

FIG. 2 is an enlarged view of the cross section shown in FIG. 1; and

FIG. 3 is a schematic perspective view of internal volumes defined by an annular hydraulic sealing gallery and feed drillings connected to the sealing gallery.

### DETAILED DESCRIPTION

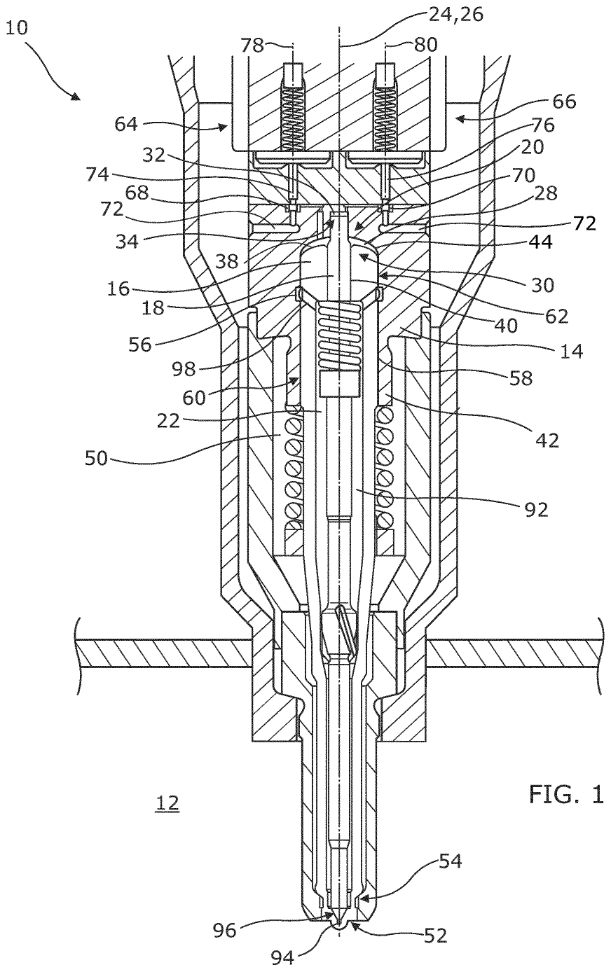

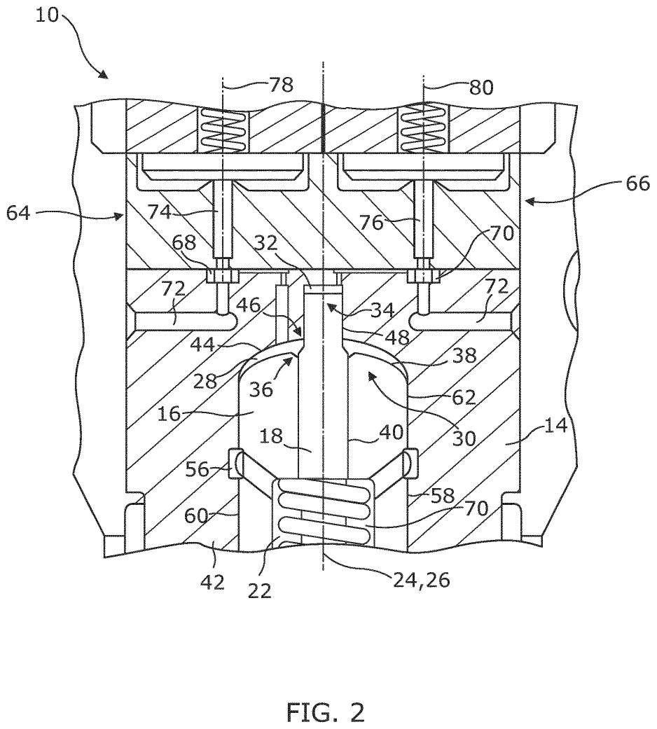

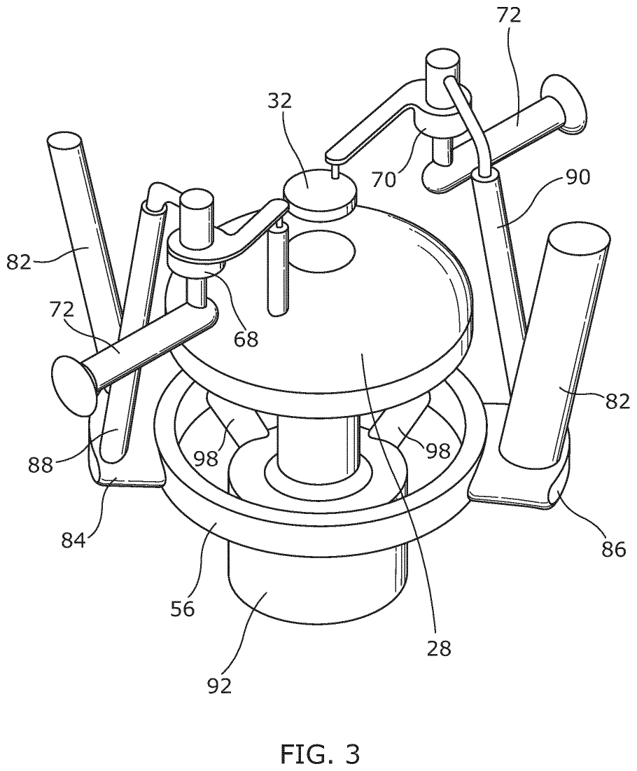

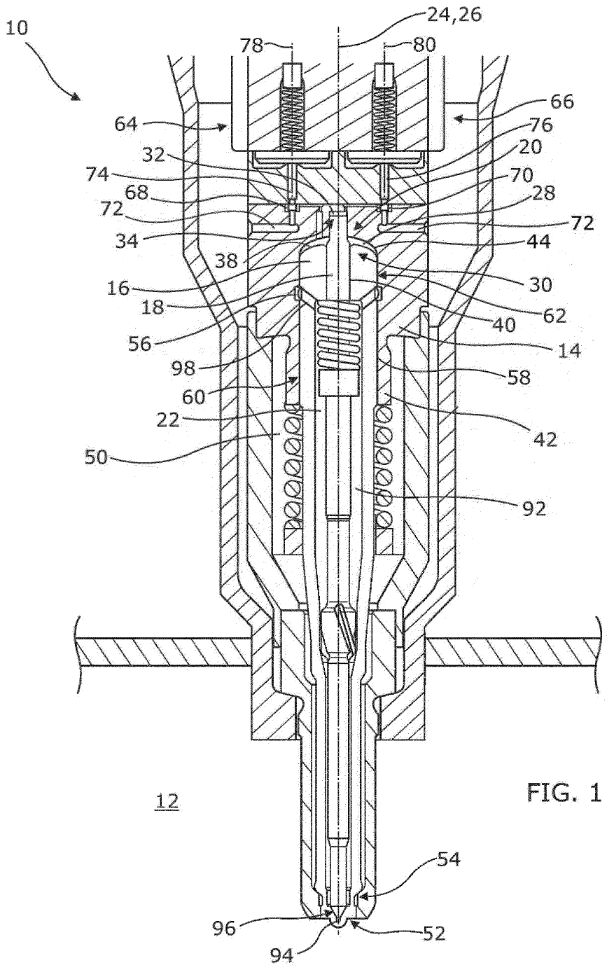

FIG. 1 is a schematic cross-sectional view of a dual-fuel injector 10 for injecting two separate fuels into a combustion chamber 12 of an internal combustion engine. For example, the injector 10 may be configured to inject a first fuel in gaseous form, such as methane or hydrogen for example, and a second fuel in liquid form, such as petrol (gasoline) or diesel for example. As explained previously by way of background, the first fuel may be selected for its advantageous combustion or emissions characteristics and the second fuel supplied to the combustion chamber 12 may help to improve the reliability and timing of the combustion of the first fuel.

The dual-fuel injector 10 comprises a nozzle body 14 housing a first fuel needle valve 16 and a second fuel needle valve 18. In some examples, as shown in the accompanying figures, the first fuel needle valve 16 and the second fuel needle valve 18 may be comprised in a dual needle valve arrangement 20. For example, the first fuel needle valve 16 may define an internal bore 22, and the second fuel needle valve 18 may be slidably received within the internal bore 22. The first and second fuel needle valves may be arranged co-axially in the dual needle valve arrangement 20, for example, longitudinal axes 24, 26 of the first and second fuel needle valves may be co-axial.

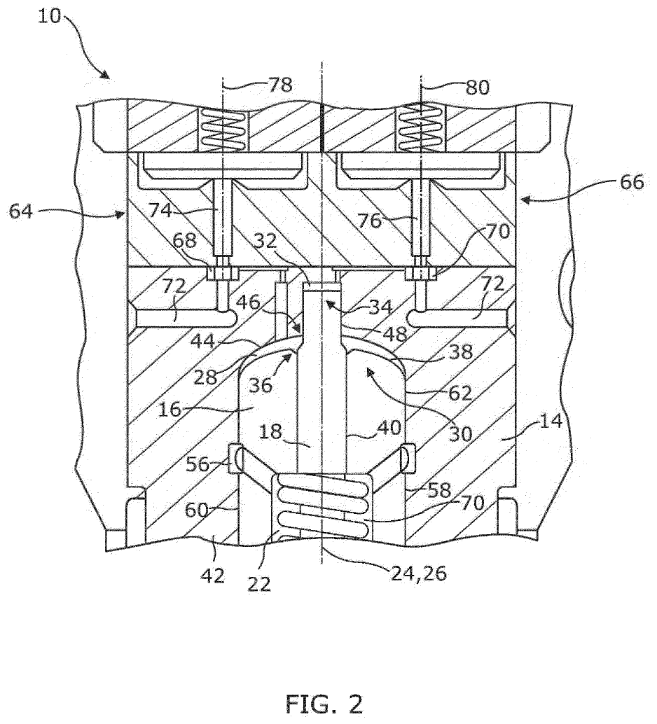

As shown in FIG. 1, and more clearly in the enlarged cross-sectional view in FIG. 2, the dual-fuel injector 10 includes a first fuel control chamber 28 for actuating the first fuel needle valve 16. The first fuel control chamber 28 is defined at least in part by an upper end 30 of the first fuel needle valve 16. Accordingly, varying a first pressure in the first fuel control chamber 28 varies the force on the upper end 30 of the first fuel needle valve 16, and thereby actuates the first fuel needle valve 16. Similarly, the injector comprises a second fuel control chamber 32 for actuating the second fuel needle valve 18. The second fuel control chamber 32 is defined at least in part by an upper end 34 of the second fuel needle valve 18. It follows that varying a second pressure in the second fuel control chamber 32 varies the force on the upper end 34 of the second fuel needle valve 18, thereby actuating the second fuel needle valve 18.

Referring more specifically now to FIG. 2, in some examples the second fuel needle valve 18 may extend through the first fuel control chamber 28. For example, the first fuel needle valve 16 may have an aperture 36 defined in an upper surface 38 of the upper end 30 of the first fuel needle valve 16, and the second fuel needle valve 18 may be slidably received within a bore 40 extending from the aperture 36 and through the upper end 30 of the first fuel needle valve 16. Accordingly, as shown in FIG. 2, in some examples the second fuel needle valve 18 may protrude from the aperture 36 such that the upper end 34 of the second fuel needle valve 18 extends above, i.e. beyond, the upper end 30 of the first fuel needle valve 16.

With reference still to FIG. 2, in some preferred examples the nozzle body 14 may define a needle guide portion 42 for slidably receiving the upper end 30 of the first fuel needle valve 16. With the first fuel control chamber 28 being defined at least in part by the upper end 30 of the first fuel needle valve 16, it will be appreciated that in such an example the first fuel control chamber 28 may be at least partially defined by a ceiling surface 44 of the needle guide portion 42. As shown in FIG. 2, an aperture 46 may be defined in the ceiling surface 44 of the needle guide portion 42, and the upper end 34 of the second fuel needle valve 18 may be received within a bore 48 extending from the ceiling aperture 46. With the upper end 34 of the second fuel needle valve 18 at least partially defining the second fuel control chamber 32 and extending above the upper end 30 of the first fuel needle valve 16, it will be appreciated that the second fuel control chamber 32 may be partially defined by the bore 48 extending from the ceiling aperture 46, in some examples.

Referring briefly back to FIG. 1, and with continued reference to FIG. 2, in some examples the nozzle body 14 may define at least part of a first fuel accumulator volume 50, i.e. a volume for receiving and accumulating the first fuel before it is supplied to the combustion chamber 12. In order to facilitate the supply of the first fuel from the first fuel accumulator volume 50 to the combustion chamber 12, the nozzle body 14 may also define one or more first fuel injection outlets 52 in fluid communication with the first fuel accumulator volume 50. For example, the or each first fuel injection outlet may be defined by a first fuel valve seat portion 54 of the nozzle body 14 such that when the first fuel needle valve 16 engages the first fuel valve seat portion 54 in use, the or each first fuel injection outlet 52 is blocked.

As shown in both FIGS. 1 and 2, the dual-fuel injector 10 includes an annular hydraulic sealing gallery 56 extending around an outer surface 58 of the first fuel needle valve 16. In some preferred examples, the sealing gallery provides a hydraulic seal between the first fuel accumulator volume 50 and the first fuel control chamber 28. Accordingly, the sealing gallery is preferably configured to inhibit the transfer or ingress of any of the first fuel from the first fuel accumulator volume 50 to the first fuel control chamber 28. This helps to prevent the first fuel from contaminating the fluid in the first fuel control chamber 28.

The annular hydraulic sealing gallery 56 is fluidly coupled to a source of high-pressure fluid. For example, the source of high-pressure fluid may be a high-pressure common fuel rail (not shown). In some advantageous examples, in use, the annular hydraulic sealing gallery 56 may therefore comprise fluid maintained at a higher pressure than the first fuel in the first fuel accumulator volume 50. This pressure differential further blocks or inhibits ingress of the first fuel to the first fuel control chamber 28.

Additionally, in some examples the first fuel accumulator volume 50 and the annular hydraulic sealing gallery 56 may be separated by a first portion of matched clearance fit 60 between the first fuel needle valve 16 and the needle guide portion 42. The first portion of matched clearance fit 60 may provide an initial sealing function, with the sealing gallery ensuring that further ingress of any small amount of first fuel that does progress through the first portion of matched clearance is prevented.

In use, the fluid in the first fuel control chamber 28 and the annular hydraulic sealing gallery 56 may be the same fluid. As such, a small transfer of fluid between the sealing gallery and first fuel control chamber 28 may not be problematic in terms of contamination. However, to improve actuation performance of the first fuel needle valve 16, it may be preferably for the first fuel control volume to be sealed as far as is possible with the sliding arrangement of the first fuel needle valve 16 in the nozzle guide portion. Accordingly, the dual-fuel injector 10 may comprise a second portion of matched clearance fit 62 between the first fuel needle valve 16 and the needle guide portion 42 to separate the first fuel control chamber 28 and the annular hydraulic sealing gallery 56.

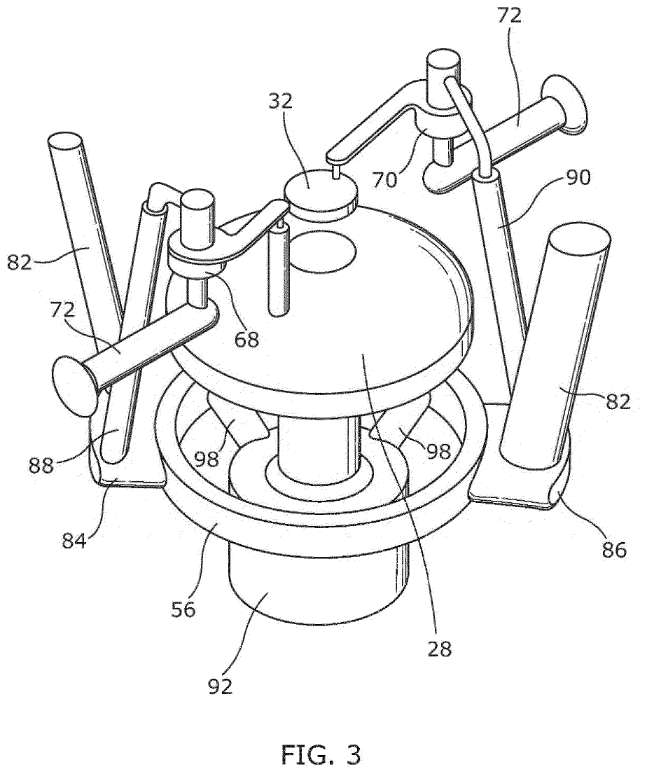

Referring still to FIGS. 1 and 2, but with additional reference to FIG. 3, the dual-fuel injector 10 comprises a first fuel control valve 64 and a second fuel control valve 66 for respectively actuating the first and second fuel needle valves 16, 18. For example, the first and second control valves 64, 66 are preferably configured to facilitate control of the first and second pressures in the first and second fuel control chambers 28, 32 to thereby control actuation of the first and second fuel needle valves 16, 18. As shown most clearly in FIGS. 2 and 3, the first fuel control valve 64 therefore defines a first switching volume 68 that is fluidly coupled to the first fuel control chamber 28, and the second fuel control valve 66 defines a second switching volume 70 that is fluidly coupled to the second fuel control chamber 32.

For example, the control valves 64, 66 may be three-way valves such that the respective switching volume 68, 70 provides a fluid flow path between the respective fuel control chamber 28, 32 and the source of high-pressure fluid, and another fluid flow path between the respective fuel control chamber 28, 32 and a low-pressure fluid drain 72, in some examples. As shown in FIGS. 1 and 2, each fuel control valve 64, 66 may facilitate selective fluid coupling of the respective fuel control chamber 28, 32 to the source of high-pressure fluid or to the low-pressure fluid drain 72 by moving a respective plunger 74, 76 along a respective control valve axis 78, 80 to block or open the relevant fluid flow path.

Reference is now made more particularly to FIG. 3 which indicates a possible schematic example of internal volumes defined by some of the internal geometry and hydraulic routing of the dual-fuel injector 10.

As previously described, the annular hydraulic sealing gallery 56 is fluidly coupled to a source of high-pressure fluid, for example via a feed conduit 82. Notably, the annular hydraulic sealing gallery 56 is also fluidly coupled to at least one of the first switching volume 68 and the second switching volume 70. As shown in FIG. 3, in some preferred examples the sealing gallery 56 may be fluidly coupled to both the first and second switching volumes 68, 70. The respective switching volume 68, 70 is therefore fluidly coupled to the source of high-pressure fluid via the sealing gallery 56. This means that the switching volume 68, 70 of a respective control valve 64, 66 is fed high-pressure fluid via the annular hydraulic sealing gallery 56. This is advantageous because the amount and complexity of hydraulic routing in the injector 10 can be reduced by utilizing some of the hydraulic routing and connections included anyway for the sealing gallery 56, i.e. separate, additional, hydraulic feeds and external connections are not required for supplying high-pressure fluid to the respective switching volume 68, 70. Ultimately this simplifies installation of the injector 10 in an engine, and also facilitates a reduction in the size of the injector 10 which is advantageous for packaging considerations.

With reference still to FIG. 3, in some preferred examples, the injector may additionally include one or more connection ducts 84, 86 which extend radially outward from the annular hydraulic sealing gallery 56. The connection ducts 84, 86 are in fluid communication with the hydraulic sealing gallery 56. The connection ducts 84, 86 may advantageously extend, i.e. widen, the sealing gallery 56 in specific locations to facilitate improved connection of a respective feed drilling 88, 90 to the sealing gallery 56. Accordingly, in some examples the or each switching volume 68, 70 may be fluidly coupled to the annular hydraulic sealing gallery 56 via a respective feed drilling 88, 90 which fluidly connects the respective switching volume 68, 70 and a connection duct 84, 86 that extends from the sealing gallery 56. The connection ducts 84, 86 greatly simplify the manufacture of the feed drillings 88, 90 to fluidly connect the respective switching volume 68, 70 to the sealing gallery 56. For example, in particularly advantageous examples the feed drillings 88, 90 may be substantially straight, and this configuration may be facilitated by the provision of the connection ducts 84, 86.

Finally, referring again to FIGS. 1 and 2, the first fuel needle valve 16 may define a second fuel accumulator volume 92 for receiving and accumulating the second fuel before this is supplied to the combustion chamber 12, in some examples. Further, the first fuel needle valve 16 may define one or more second fuel injection outlets 94 in fluid communication with the second fuel accumulator volume 92 for injecting the second fuel from the second fuel accumulator volume 92 into the combustion chamber 12. The or each second fuel injection outlet 94 may be defined by a second fuel valve seat portion 96 configured such that when the second fuel needle valve 18 engages the second fuel valve seat portion 96 in use, the or each second fuel injection outlet 94 is blocked.

In addition to one or more of the above-described functions, the multi-functional annular hydraulic sealing gallery 56 may also facilitate supply of the second fuel to the second fuel accumulator volume 92. For example, as shown in each of the accompanying figures, the first fuel needle valve 16 may comprise one or more feed conduits 98 which provide fluid communication between the annular hydraulic sealing gallery 56 and the second fuel accumulator volume 92. The second fuel may therefore be supplied to the second fuel accumulator volume 92 via the sealing gallery 56. It will be appreciated that the high-pressure fluid in the sealing gallery 56 may therefore be the second fuel. Again, such a configuration advantageously reduces the amount and complexity of hydraulic routing in the dual-fuel injector 10.

It will be appreciated that the description provided above serves to demonstrate possible examples of the present invention. Features described in relation to any of the examples above may be readily combined with any other features described with reference to different examples without departing from the scope of the invention as defined in the appended claims.

1. A dual-fuel injector for injecting two separate fuels into a combustion chamber of an internal combustion engine, the dual-fuel injector comprising:
a nozzle body housing a first fuel needle valve and a second fuel needle valve;
a first fuel control chamber defined at least in part by an upper end of the first fuel needle valve such that varying a first pressure in the first fuel control chamber varies the force on the upper end of the first fuel needle valve;
a second fuel control chamber defined at least in part by an upper end of the second fuel needle valve such that varying a second pressure in the second fuel control chamber varies the force on the upper end of the second fuel needle valve;
a first fuel control valve defining a first switching volume fluidly coupled to the first fuel control chamber for actuating the first fuel needle valve;
a second fuel control valve defining a second switching volume fluidly coupled to the second fuel control chamber for actuating the second fuel needle valve; and
an annular hydraulic sealing gallery extending around an outer surface of the first fuel needle valve,
wherein the annular hydraulic sealing gallery is fluidly coupled to a source of high-pressure fluid and to at least one of the first switching volume and/or the second switching volume such that the respective switching volume is fluidly coupled to the source of high-pressure fluid via the sealing gallery.

2. The dual-fuel injector of claim 1, wherein the first fuel needle valve and second fuel needle valve are comprised in a dual needle valve arrangement, wherein the first fuel needle valve defines an internal bore and wherein the second fuel needle valve is slidably received within the internal bore.

3. The dual-fuel injector of claim 1, further comprising one or more connection ducts extending radially outward from the annular hydraulic sealing gallery wherein the or each switching volume is fluidly coupled to the annular hydraulic sealing gallery via a respective feed drilling connecting the switching volume and the connection duct.

4. The dual-fuel injector of claim 1, wherein the nozzle body defines a needle guide portion and wherein the upper end of the first fuel needle valve is slidably received in the needle guide portion.

5. The dual-fuel injector of claim 4, wherein the nozzle body defines at least part of a first fuel accumulator volume and one or more first fuel injection outlets in fluid communication with the first fuel accumulator volume for injecting the first fuel from the first fuel accumulator volume into the combustion chamber.

6. The dual-fuel injector of claim 5, wherein the first fuel accumulator volume and the annular hydraulic sealing gallery are separated by a first portion of matched clearance fit between the first fuel needle valve and the needle guide portion.

7. The dual-fuel injector of claim 5, wherein the annular hydraulic sealing gallery comprises a fluid maintained at a higher pressure than the first fuel in the first fuel accumulator volume.

8. The dual-fuel injector of any of claim 4, wherein the first fuel control chamber is defined at least in part by a ceiling surface of the needle guide portion.

9. The dual-fuel injector of claim 8, wherein the first fuel control chamber and the annular hydraulic sealing gallery are separated by a second portion of matched clearance fit between the first fuel needle valve and the needle guide portion.

10. The dual-fuel injector of claim 4, wherein the first fuel control chamber is defined at least in part by a ceiling surface of the needle guide portion, wherein the nozzle body comprises a bore extending from an aperture defined in the ceiling surface of the needle guide portion, wherein the upper end of the second fuel needle valve is received within the bore, and wherein the second fuel control chamber is defined, at least in part, by the bore.

11. The dual-fuel injector of claim 1, wherein the second fuel needle valve extends through the first fuel control chamber.

12. The dual-fuel injector of claim 1, wherein the first fuel needle valve defines a second fuel accumulator volume and one or more second fuel injection outlets in fluid communication with the second fuel accumulator volume for injecting the second fuel from the second fuel accumulator volume into the combustion chamber.

13. The dual-fuel injector of claim 12, wherein the first fuel needle valve comprises one or more feed conduits facilitating fluid communication between the annular hydraulic sealing gallery and the second fuel accumulator volume.

14. The dual-fuel injector of claim 1, wherein the first fuel needle valve comprises a bore extending through the upper end of the first fuel needle valve from an aperture defined in an upper surface, wherein the second fuel needle valve is slidably received within the first fuel needle valve bore, and wherein the second fuel needle valve protrudes from the aperture such that an upper end of the second fuel needle valve extends above the upper end of the first fuel needle valve.

15. The dual-fuel injector of claim 1, wherein the first fuel control valve comprises a first plunger configured to move along a first control valve axis to selectively fluidly couple the first fuel control chamber to a low-pressure fluid drain or to the source of high-pressure fluid via the annular hydraulic sealing gallery, and/or
wherein the second fuel control valve comprises a second plunger configured to move along a second control valve axis to selectively fluidly couple the second fuel control chamber to a low-pressure fluid drain or to the source of high-pressure fluid via the annular hydraulic sealing gallery.

16. The dual-fuel injector of claim 15, wherein the first and second fuel control valves are arranged side-by-side such that the first control valve axis extends parallel to the second control valve axis, wherein both the first and second control valve axes extend parallel to a first needle valve axis of the first fuel needle valve, and wherein both the first and second control valve axes are offset from the first needle valve axis such that neither control valve axis is co-axial with the first needle valve axis.
